(19) United States
(12) Patent Application Publication
(10) Pub. No.: US 2023/0090048 A1
(43) Pub. Date: Mar. 23, 2023

(54) QUERYING VEHICLE INVENTORY SYSTEMS FOR SCHEDULING OF INTERACTIONS WITH AVAILABLE VEHICLES

(71) Applicant: Capital One Services, LLC, McLean, VA (US)

(72) Inventor: Anthony SHUI, South Lyon, MI (US)

(21) Appl. No.: 17/448,417

(22) Filed: Sep. 22, 2021

(51) Int. Cl. G06Q 10/06; G06Q 10/08; G06Q 10/10; G06F 16/245; G06F 16/248; G06F 16/29

(52) U.S. Cl. CPC G06Q 10/06315; G06Q 10/087; G06Q 10/1093; G06F 16/245; G06F 16/248; G06F 16/29; G06Q 40/025

(57) ABSTRACT

In some implementations, a server may receive, from a client device, vehicle preference information and an indication of a location associated with the customer. The server may transmit, to a vehicle inventory system, a search query that indicates the vehicle preference information and the location associated with the customer. The server may receive, from the vehicle inventory system, a response that indicates an available vehicle based on the vehicle preference information and the location. The server may transmit, to a vehicle dealership system associated with the available vehicle, a request for scheduling an interaction for the customer to view the available vehicle. The server may receive, from the vehicle dealership system, a confirmation message that confirms the interaction for the customer to view the available vehicle. The server may transmit, to the client device, an indication of a schedule that indicates the interaction for the customer to view the available vehicle.

### BACKGROUND

A customer may view vehicles in person at a vehicle dealership before purchasing a vehicle. The customer may visit the vehicle dealership in person to assess the vehicles available for sale and compare features associated with the vehicles. The customer may visit the vehicle dealership in person to test drive certain vehicles. The customer may select a vehicle for purchase based on various criteria, such as a make, model, year, quantity of miles, and/or color.

### SUMMARY

In some implementations, a system for querying vehicle inventory systems for scheduling of interactions to view available vehicles includes memory and one or more processors, communicatively coupled to the memory, configured to: receive, from an application that executes on a client device, vehicle preference information that indicates a vehicle preference associated with a customer; receive, from the application that executes on the client device, customer information that indicates one or more characteristics associated with the customer; receive, from the application that executes on the client device, an indication of a location associated with the customer; transmit, to a vehicle inventory system, a search query that indicates the vehicle preference information and the location associated with the customer, wherein the vehicle inventory system is associated with a database that stores vehicle availability information associated with a plurality of vehicle dealerships in a plurality of geographic locations; receive, from the vehicle inventory system, a response that indicates one or more available vehicles that are retrieved from the database based on the search query indicating the vehicle preference information and the location associated with the customer, wherein the one or more available vehicles are associated with one or more vehicle dealerships of the plurality of vehicle dealerships, and wherein the one or more vehicle dealerships are located within a defined distance from the location associated with the customer; transmit, to one or more vehicle dealership systems associated with the one or more available vehicles, one or more requests for scheduling one or more interactions for the customer to view the one or more available vehicles, wherein the one or more requests indicate the customer information; receive, from the one or more vehicle dealership systems, one or more confirmation messages that confirm one or more interactions for the customer to view the one or more available vehicles; and transmit, to the application that executes on the client device, an indication of a schedule that indicates the one or more interactions for the customer to view the one or more available vehicles.

In some implementations, a method of querying vehicle inventory systems for scheduling of interactions to view available vehicles includes receiving, at a server from an application that executes on a client device, vehicle preference information that indicates a vehicle preference associated with a customer; receiving, at the server from the application that executes on the client device, an indication of a location associated with the customer; transmitting, from the server to a vehicle inventory system, a search query that indicates the vehicle preference information and the location associated with the customer; receiving, at the server from the vehicle inventory system, a response that indicates an available vehicle based on the vehicle preference information, wherein the available vehicle is associated with a vehicle dealership that is located within a defined distance from the location associated with the customer; transmitting, from the server to a vehicle dealership system associated with the available vehicle, a request for scheduling an interaction for the customer to view the available vehicle; receiving, at the server from the vehicle dealership system, a confirmation message that confirms the interaction for the customer to view the available vehicle; and transmitting, from the server to the application that executes on the client device, an indication of a schedule that indicates the interaction for the customer to view the available vehicle.

In some implementations, a non-transitory computer-readable medium storing a set of instructions includes one or more instructions that, when executed by one or more processors of a device, cause the device to: receive, at an application that executes on a client device, vehicle preference information that indicates a vehicle preference associated with a customer; receive, at the application that executes on the client device, customer information that indicates one or more characteristics associated with the customer; receive, at the application that executes on the client device, an indication of a location associated with the customer; transmit, from the application that executes on the client device to a server, the vehicle preference information, the customer information, and the indication of the location associated with the customer; receive, at the application that executes on the client device from the server, an indication of a schedule that indicates one or more interactions for the customer to view one or more available vehicles, wherein the one or more available vehicles are based on the vehicle preference information, the customer information, and the indication of the location associated with the customer, and wherein the one or more available vehicles are associated with one or more vehicle dealerships that are located within a defined distance from the location associated with the customer; and provide the indication of the schedule for display on a user interface of the client device.

### BRIEF DESCRIPTION OF THE DRAWINGS

FIGS. 1A-1F are diagrams of an example implementation relating to querying vehicle inventory systems for scheduling of interactions to view available vehicles.

FIG. 2 is a diagram of an example environment in which systems and/or methods described herein may be implemented.

FIG. 3 is a diagram of example components of one or more devices of FIG. 2.

FIG. 4 is a flowchart of an example process relating to querying vehicle inventory systems for scheduling of interactions to view available vehicles.

### DETAILED DESCRIPTION

The following detailed description of example implementations refers to the accompanying drawings. The same reference numbers in different drawings may identify the same or similar elements.

A customer may be interested in purchasing a vehicle and may perform research on vehicle dealerships that are located in proximity (e.g., within 15 miles) of the customer and types of vehicles that are available for sale at those vehicle dealerships. For example, a client device associated with the customer may provide a user interface. The user interface may be associated with a browser or an application. The client device may receive, via the user interface, a search query for vehicle dealerships that offer a particular make and model of a vehicle for sale. The client device may perform the search query and display search results based on the search query. The search results may indicate a listing of vehicle dealerships that are located in proximity of the customer and may potentially provide that particular make and model of the vehicle for sale.

After receiving the listing of vehicle dealerships, the client device may individually access a website associated with each of the different vehicle dealerships. For example, each vehicle dealership may have a separate website which provides information on different vehicles that are available for sale. A website associated with a particular vehicle dealership may allow a search query to be entered that specifies, for example, a particular make, model, year, color, quantity of miles, and/or features. Search results may indicate vehicles that are available for sale at that particular vehicle dealership. The vehicles that are indicated as being available for sale may at least partially match the search query. The client device may access each website individually, such that the customer may become notified of available vehicles at the different vehicle dealerships.

In some cases, a website associated with a particular vehicle dealership may include a form to schedule an appointment, which may allow the customer to view a vehicle and/or test drive the vehicle. The client device may provide information (e.g., customer name, telephone number, etc.) via the form to schedule the appointment to view and/or test drive one or more available vehicles. The client device may access multiple websites to schedule multiple appointments with the different vehicle dealerships. In some cases, the customer may manually call the different vehicle dealerships to schedule the appointments. The customer may visit the different vehicle dealerships during a vehicle purchasing process.

In some cases, the customer may visit a vehicle dealership without an appointment. In these cases, certain makes and/or models of vehicles may not be physically available for the customer to view and/or test drive. Further, the customer may wish to view and/or interact with certain features in person (e.g., a certain audio system), but vehicles that possess those features may not currently be present at the vehicle dealership when the customer does not make an appointment ahead of time.

An amount of computer resources (e.g., processing resources and/or network resources) expended by the client device when transmitting/receiving information associated with different vehicle dealerships, transmitting/receiving information associated with an availability of certain vehicles at those different vehicle dealerships, and/or transmitting/receiving information associated with scheduling appointments to view and/or test drive those certain vehicles may be burdensome. Further, an amount of time required by the customer to visit multiple websites when researching the different vehicle dealerships, determining the availability of certain vehicles at those different vehicle dealerships, and/or scheduling the appointments to view and/or test drive those certain vehicles may be burdensome.

In some implementations described herein, to solve the problems described above, as well as a related technical problem of how to create an application that provides a customer with real-time inventory information of different vehicle dealerships that are located in proximity to the customer and to automatically schedule appointments with those vehicle dealerships, a technical solution is described herein for executing an application on a client device that transmits vehicle preference information, customer information, and location information to a server. The server may transmit a search query to a vehicle inventory system based on the vehicle preference information, the customer information, and the location information. The vehicle inventory system may transmit, to the server, a response that indicates available vehicles based on the search query. The server may communicate with vehicle dealership systems associated with the available vehicles to schedule appointment times for viewing and/or test driving the available vehicles. After the appointments are established, the server may transmit an indication of a schedule of the appointments to the application that executes on the client device. As a result, the customer may be presented with a listing of appointments to view/test drive vehicles at different vehicle dealerships.

In some implementations, the application executing on the client device may receive the vehicle preference information, the customer information, and the location information via a single user interface. The application may transmit the vehicle preference information, the customer information, and the location information to the server. The server may have access to the vehicle inventory system, which may maintain a real-time vehicle inventory for a plurality of vehicle dealerships. The vehicle inventory system may be updated in real-time when a particular vehicle is sold at a vehicle dealership or when a new vehicle becomes available at a vehicle dealership. The vehicle inventory system may notify the server of available vehicles that at least partially match the vehicle preference information, the customer information, and/or the location information. Further, the server may be able to directly access vehicle dealership systems associated with the available vehicles indicated by the vehicle inventory system. The server may be able to set up appointments to view and/or test drive the available vehicles based on messaging between the server and the vehicle dealership systems.

In some implementations, vehicle dealership systems may communicate with each other to facilitate an exchange of vehicles between vehicle dealerships associated with the vehicle dealership systems. Vehicles that are exchanged between the vehicle dealerships may be interacted with by customers. Interactions (e.g., test drives) may occur at a vehicle dealership or at a common area shared by the vehicle dealerships. For example, the vehicle dealerships may show vehicles to customers at the common area, and not necessarily at the vehicle dealerships themselves.

In some implementations, by having the server identify the available vehicles and schedule appointments to view and/or test drive the available vehicles, resources may be saved at the client device. For example, the client device may consume less processing power, less battery consumption, and less network resources, as much of the processing is now shifted to the server. Further, having the server identify the available vehicles and schedule appointments to view and/or test drive the available vehicles may save the customer a considerable amount of time, as the customer does not need to spend time visiting different websites associated with the different vehicle dealerships to determine which vehicles are available, and the customer does not need to spend time trying to schedule appointments with the different vehicle dealerships to view and/or test drive the available vehicles.

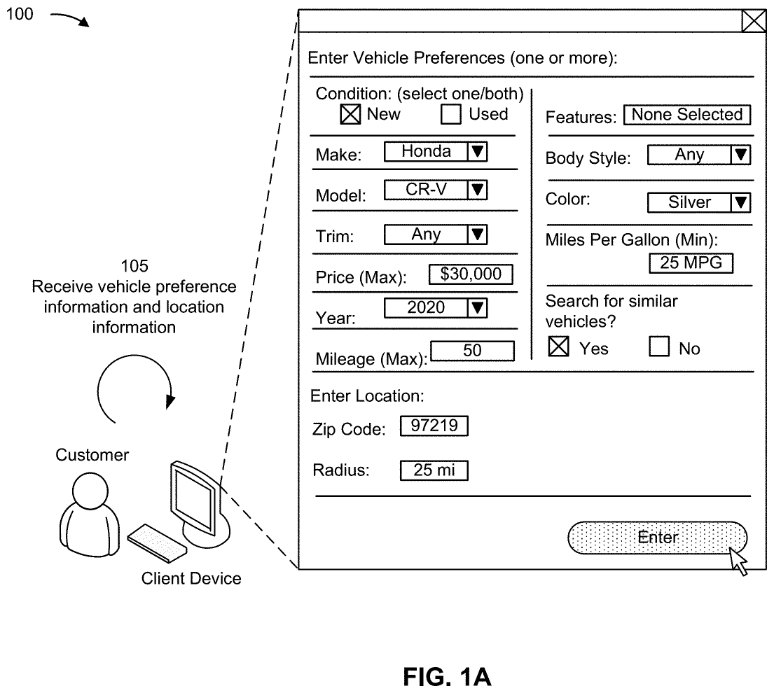

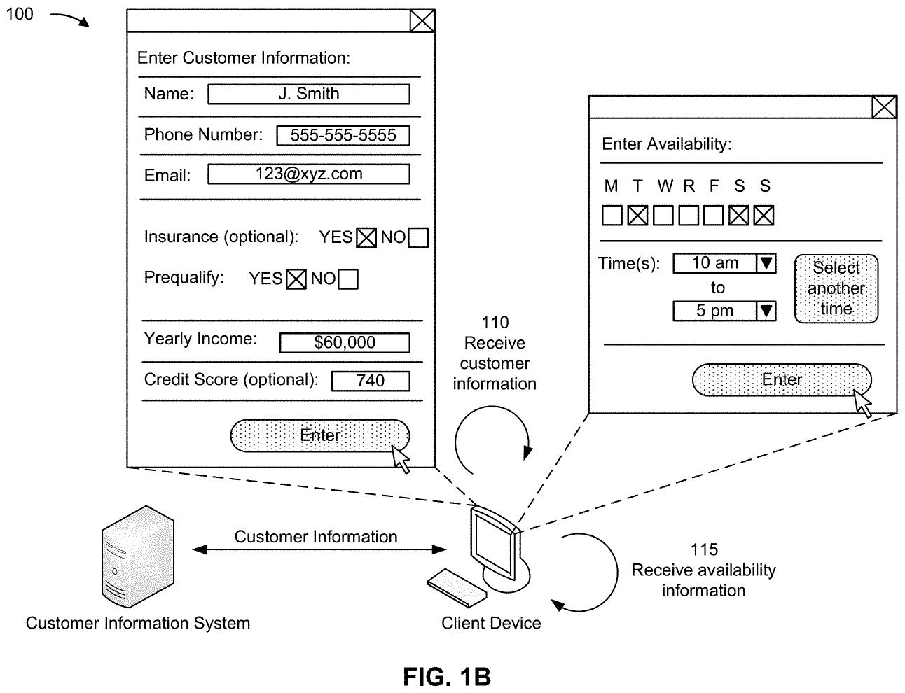

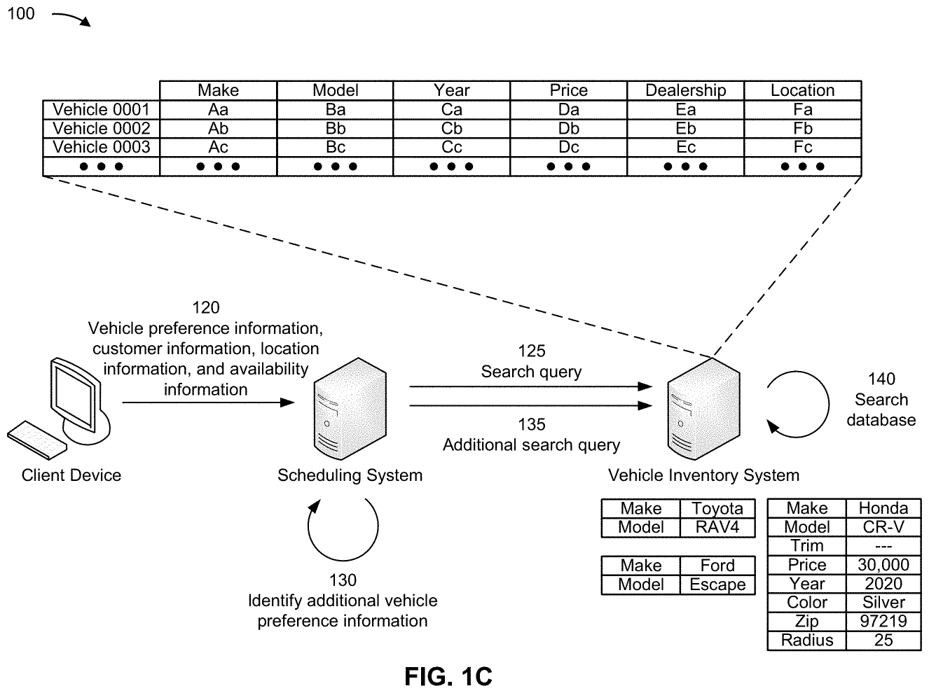

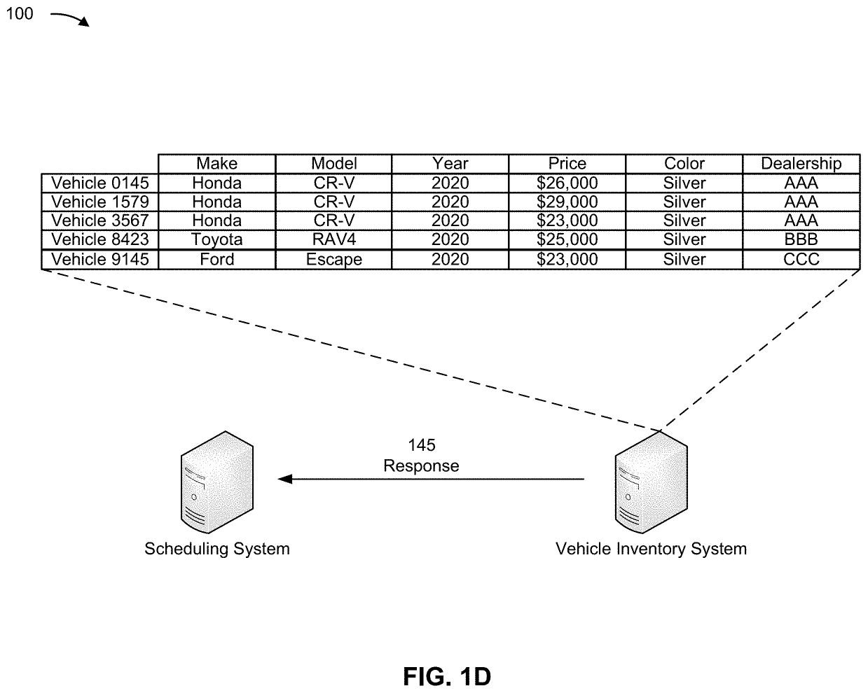

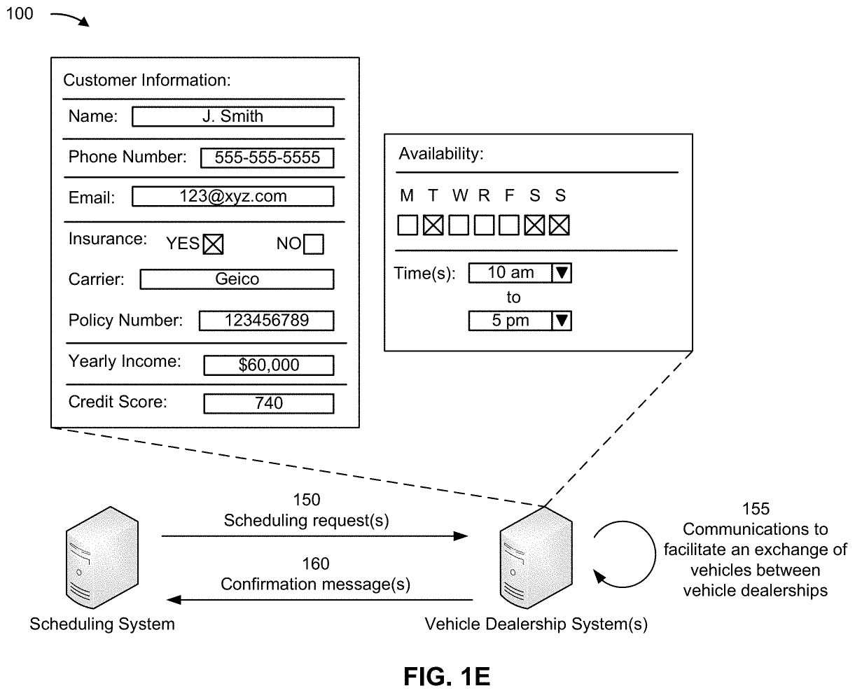

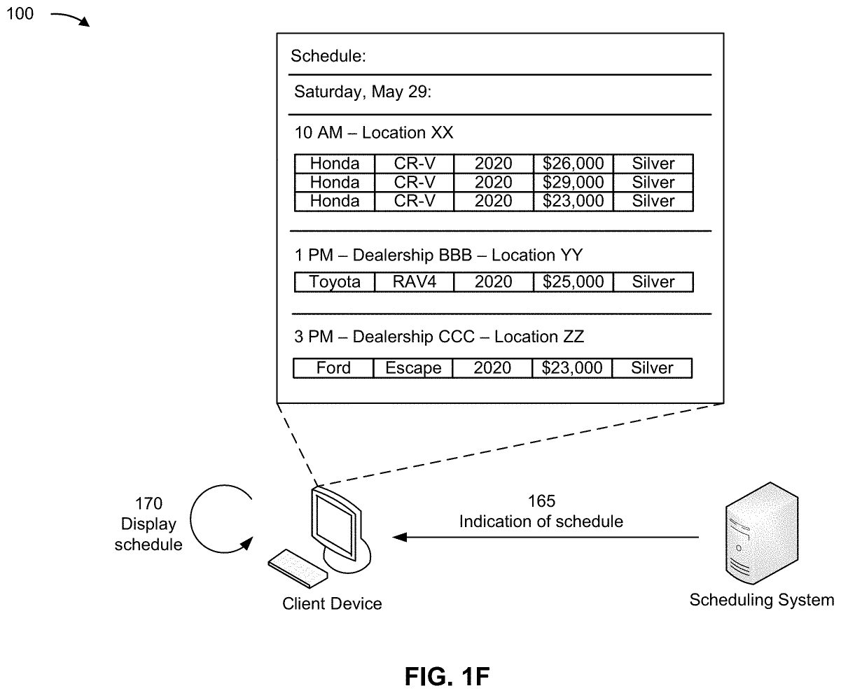

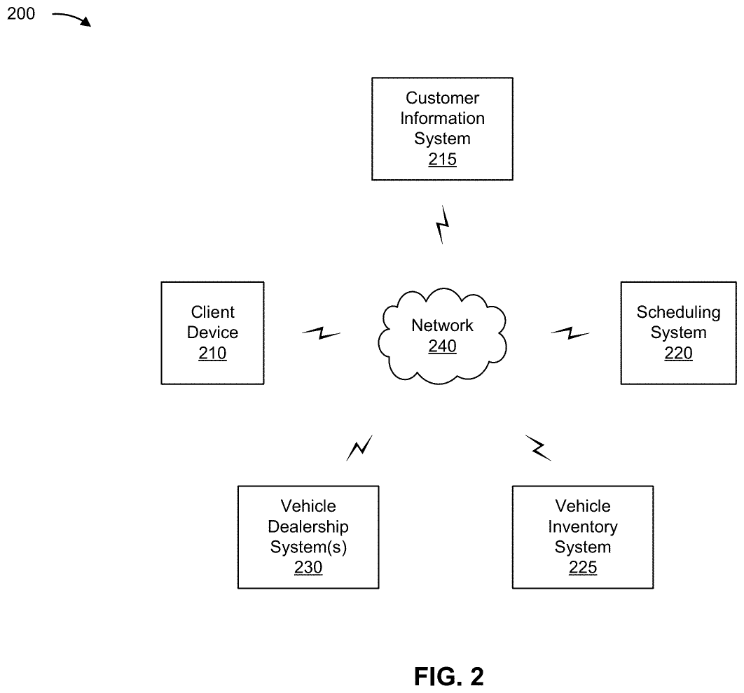

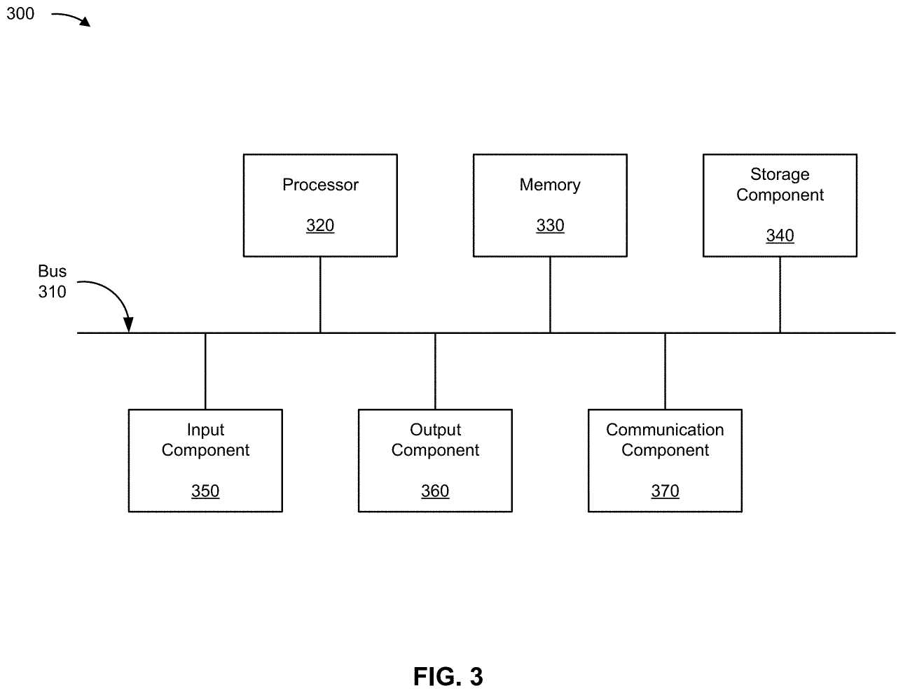

FIGS. 1A-1F are diagrams of an example implementation 100 related to querying vehicle inventory systems for scheduling of interactions to view available vehicles. As shown in FIGS. 1A-1F, example implementation 100 includes a client device, a customer information system, a scheduling system, a vehicle inventory system, and a vehicle dealership system. These devices are described in more detail in connection with FIGS. 2 and 3.

In some implementations, an application that executes on the client device may facilitate a querying of vehicle inventory systems for scheduling of interactions to view available vehicles. The application may be used by a customer during a vehicle purchasing experience. For example, the application may enable the customer to research vehicles, vehicle dealerships that are within a distance from the customer that offer the vehicles for sale, and/or schedule appointments to view and/or test drive the vehicles. In some cases, functionality for facilitating vehicle purchases may be the primary purpose of the application. Alternatively, the functionality for facilitating vehicle purchases may be integrated into an application that provides other functions, such as banking functions.

In some implementations, the querying of vehicle inventory systems for scheduling of interactions to view available vehicles may be via a website instead of the application that executes on the client device. For example, the client device may access the website, which may provide customers with an ability to research vehicles, vehicle dealerships that are within a distance from the customer that offer the vehicles for sale, and/or schedule appointments to view and/or test drive the vehicles.

As shown in FIG. 1A, and by reference number 105, the application may receive vehicle preference information and location information via a user interface associated with the application. The vehicle preference information and the location information may be associated with a customer that uses the client device. The vehicle preference information may indicate a vehicle preference associated with the customer. The vehicle preference information may be associated with a type of vehicle that the customer is interested in purchasing. The location information may indicate a location associated with the customer.

In some implementations, the vehicle preference information may include a condition associated with the vehicle (e.g., new or used), a make associated with the vehicle (e.g., Honda), a model associated with the vehicle (e.g., CR-V), a trim associated with the vehicle, a price associated with the vehicle (e.g., a maximum price or a price range), a year (or range of years) associated with the vehicle, a mileage range or threshold associated with the vehicle, features associated with the vehicle, a body style associated with the vehicle, a color or a plurality of colors associated with the vehicle, and/or a fuel economy or range associated with the vehicle. In some implementations, the location information may indicate the location (e.g., an address, a zip code, and/or city and state) associated with the customer, as well as a radius (e.g., 25 miles) that the customer is willing to travel to purchase a vehicle.

In some implementations, the condition, make, model, trim, price, year, mileage range, features, body style, color, and/or fuel economy or range may be provided via the user interface associated with the application. In some implementations, the location information may be provided via the user interface associated with the application. In some implementations, the user interface may include an option to search for similar vehicles. For example, the option may be selected when the customer is favorable to receiving search results for vehicles that are of a similar make, model, trim, body style, price, year, mileage, and/or color as compared to the vehicle preference information.

In some implementations, the application may allow the customer to perform a relatively wide search of vehicles by entering the vehicle preference information. The customer may search for vehicles using various levels of vehicle preference information. For customers that do not have a strong preference on a certain make, model, and/or trim, the customer may select a general vehicle type (e.g., sedan or truck) or by a number of available seats.

As shown in FIG. 1B, and by reference number 110, the application may receive customer information. The customer information may indicate one or more characteristics associated with the customer. The customer information may indicate a customer name and contact information (e.g., a telephone number and electronic mail address). The customer information may include an indication of whether the customer has vehicle insurance. If the customer has vehicle insurance, the customer information may include an insurance carrier and/or a policy number. The customer information may also include financial information associated with the customer, such as a yearly income and/or a credit score associated with the customer.

In some implementations, the application may receive the customer information via the user interface associated with the application. Alternatively, or additionally, the application may receive the customer information via a customer information system. The application may receive a first portion of the customer information via the user interface and a second portion of the customer information via the customer information system.

In some implementations, the application may receive a portion of the customer information via the user interface associated with the application, such as the customer name and contact information. The application may transmit a search query to the customer information system, where the search query may indicate the customer name and/or the contact information. The customer information system may transmit, in response to the search query, a response that indicates whether the customer has vehicle insurance, and if so, the insurance carrier and/or the policy number. In some cases, the customer may perform a “soft pull” pre-qualification instead of indicating the vehicle insurance. Further, the response may indicate the financial information associated with the customer, such as the yearly income and/or the credit score associated with the customer.

As shown by reference number 115, the application may receive availability information associated with the customer. The availability information may indicate times that the customer is available to view and/or test drive vehicles at vehicle dealerships. The application may receive the availability information via the user interface associated with the application. The availability information may indicate days of a week (e.g., Tuesday, Saturday and Sunday) during which the customer is available to view and/or test drive vehicles at vehicle dealerships. Further, the availability information may indicate times or time ranges (e.g., 10 am to 5 pm) during which the customer is available to view and/or test drive vehicles at vehicle dealerships. The availability information may indicate multiple time slots per day.

As shown in FIG. 1C, and by reference number 120, the client device may transmit, to the scheduling system, the vehicle preference information, the customer information, the location information, and/or the availability information. In other words, the client device may transmit indications of the vehicle preference(s) associated with the customer, the one or more characteristics associated with the customer, the location associated with the customer, and/or the times that the customer is available to view and/or test drive vehicles at the vehicle dealerships.

In some implementations, the vehicle preference information, the customer information, the location information, and/or the availability information may be associated with a customer profile. The customer profile may be stored locally on the client device, or alternatively, may be stored external to the client device (e.g., on the customer information system). In some cases, when the application initiates the scheduling of interactions to view available vehicles, the scheduling system may retrieve the customer profile that indicates the vehicle preference information, the customer information, the location information, and/or the availability information.

As shown by reference number 125, the scheduling system may transmit, to the vehicle inventory system, a search query that indicates the vehicle preference information associated with the customer and the location information associated with the customer. The search query may indicate the condition, make, model, trim, price, year, mileage range, features, body style, color, and/or fuel economy or range included in the vehicle preference information. The search query may indicate the location (e.g., a zip code, and/or city and state) associated with the customer, as well as the radius (e.g., 25 miles) that the customer is willing to travel to purchase the vehicle, where the location and the radius may be included in the location information.

In some implementations, the vehicle inventory system may be associated with a database that stores vehicle availability information associated with a plurality of vehicle dealerships in a plurality of geographic locations. The vehicle inventory system may maintain a listing of available vehicles and corresponding features (e.g., make, model, price, color, etc.) across the plurality of vehicle dealerships in the plurality of geographic locations. The vehicle inventory system may update the listing of available vehicles in real-time as vehicles become purchased and are no longer available. In some implementations, the vehicle inventory system may have access to individual databases associated with the plurality of vehicle dealerships. For example, when a particular vehicle is no longer available at a particular vehicle dealership, a database associated with that particular vehicle dealership may be updated to indicate that the particular vehicle is no longer available. The vehicle inventory system may be able to detect updates to the database associated with that particular vehicle dealership, and the vehicle inventory system may update the listing of available vehicles accordingly. In some implementations, the plurality of vehicle dealerships may provide the vehicle inventory system with access to individual databases associated with the plurality of vehicle dealerships. In other words, the individual databases may contain proprietary information regarding a current inventory of available vehicles and may generally not be available, but permission may be granted to the vehicle inventory system to retrieve information about updates made to the individual databases associated with the plurality of vehicle dealerships.

As an example, the vehicle inventory system may store, in the database associated with the vehicle inventory system and for an individual vehicle identifier, a make, model, year, price, vehicle dealership, and/or location (e.g., zip code) associated with the vehicle dealership. The individual vehicle identifier may be a unique identifier, such as a vehicle identification number (VIN). Within the vehicle inventory system, vehicle identifiers may be grouped by vehicle dealership, by location, by make, by model, and so on, which may enable relatively fast search queries to be performed against entries in the database associated with the vehicle inventory system.

As shown by reference number 130, the scheduling system may identify additional vehicle information based on the vehicle preference information. The additional vehicle information may indicate one or more vehicles having characteristics that are similar to the vehicle preference information provided via the user interface. The scheduling system may identify the additional vehicle information when the option to search for similar vehicles is selected via the user interface. In some implementations, the scheduling system may identify keywords associated with the vehicle preference information, where the keywords may indicate the make, model, price, year, etc. The scheduling system may access, in a database, a listing of a plurality of potential vehicles. Each vehicle indicated in the listing may be associated with a make, model, price, year, etc. In other words, each vehicle indicated in the listing may be associated with metadata, where the metadata may include the make, model, price, year, etc. The scheduling system may identify, from the listing, certain vehicles having metadata that at least partially matches the keywords identified from the vehicle preference information. The scheduling system may identify, from the listing, certain vehicles that are not necessarily the same make and model indicated in the vehicle preference information, but may have similar have a similar trim, price, year, mileage, features, body style, color, fuel economy or range, etc. Vehicles that are identified as having metadata that at least partially match the keywords identified from the vehicle preference information may form the additional vehicle information.

As shown by reference number 135, the scheduling system may transmit, to the vehicle inventory system, an additional search query that indicates the additional vehicle preference information associated with the customer. The additional search query may indicate additional conditions, makes, models, trims, prices, years, mileage ranges, features, body styles, colors, and/or fuel economies or ranges included in the additional vehicle preference information.

As an example, the search query based on the vehicle preference information and the location information may indicate Honda as the make, CR-V as the model, no trim, $30,000 as the price, 2020 as the year, silver as the color, 97219 as the zip code, and 25 miles as the radius. As another example, the additional search query based on the additional vehicle preference information may indicate Toyota as an additional make, RAV4 as an additional model, Ford as an additional make, and Escape as an additional model. The additional vehicle preference information may indicate vehicles having similar characteristics as compared to vehicles indicated in the vehicle preference information.

As shown by reference number 140, the vehicle inventory system may search the database associated with the vehicle system based on the search query and the additional search query. In other words, the vehicle inventory system may perform a search against the entries in the database using the search query and the additional search query. The vehicle inventory system may identify, based on the search against the database using the search query and the additional search query, one or more available vehicles associated with one or more vehicle dealerships located within the radius from the location associated with the customer. The one or more available vehicles may correspond to the search query and/or the additional search query.

As shown in FIG. 1D, and by reference number 145, the scheduling system may receive, from the vehicle inventory system, a response that indicates the one or more available vehicles. The one or more available vehicles may be retrieved from the database associated with the vehicle inventory system based on the search query indicating the vehicle preference information and the location information and based on the additional search query indicating the additional vehicle preference information. The one or more available vehicles may be associated with one or more vehicle dealerships of the plurality of vehicle dealerships associated with the vehicle inventory system, and the one or more vehicle dealerships may be located within the radius of the location associated with the customer.

As an example, the response indicating the one or more available vehicle may indicate a first vehicle identifier associated with a silver 2020 Honda CR-V for $26,000 at a first vehicle dealership, a second vehicle identifier associated with a silver 2020 Honda CR-V for $29,000 at the first vehicle dealership, a third vehicle identifier associated with a silver 2020 Honda CR-V for $23,000 at the first vehicle dealership, a fourth vehicle identifier associated with a silver 2020 Toyota RAV4 for $25,000 at a second vehicle dealership, and a fifth vehicle identifier associated with a silver 2020 Ford Escape for $23,000 at a third vehicle dealership. The five different vehicles indicated in the response may have similar makes, models, years, prices, and/or colors. Further, the five different vehicles indicated in the response may be associated with vehicle dealerships that are within the specified radius of the customer's location. Some of the vehicles, such as the first three Honda CR-Vs, may be associated with a same vehicle dealership, with other vehicles, such as the Toyota RAV4 and the Ford Escape, may be associated with other vehicle dealerships.

As shown in FIG. 1E, and by reference number 150, the scheduling system may transmit, to one or more vehicle dealership systems associated with the one or more available vehicles indicated in the response, one or more scheduling requests for scheduling one or more interactions for the customer to view the one or more available vehicles. An interaction may involve an appointment with a salesperson at a vehicle dealership to view a vehicle of interest and/or test drive the vehicle. In some implementations, the response indicating the one or more available vehicles may indicate contact information for the one or more vehicle dealerships associated with the one or more available vehicles. The scheduling system may transmit the one or more scheduling requests to the one or more vehicle dealership systems based on the contact information.

In some implementations, a scheduling request transmitted to a vehicle dealership system on behalf of the customer may indicate that the customer is interested in viewing one or more available vehicles in person at a vehicle dealership associated with the vehicle dealership system. The one or more available vehicles may correspond to vehicles indicated in the response received from the vehicle inventory system. In other words, the scheduling request may indicate the one or more available vehicles, which may correspond to the vehicles indicated in the response received from the vehicle inventory system. The scheduling request may indicate the customer information. For example, the scheduling request may indicate the customer's name and contact information (e.g., a telephone number and electronic mail address) associated with the customer. The scheduling request may indicate whether the customer has vehicle insurance. If the customer has vehicle insurance, the scheduling request may include an insurance carrier and/or a policy number. The scheduling request may also include financial information associated with the customer, such as a yearly income and/or a credit score associated with the customer. The scheduling request may include information regarding the vehicle insurance and/or the financial information to validate that the customer is financially able to purchase one of the available vehicles, and that the customer is insured and is able to test drive the one or more available vehicles.

In some implementations, the scheduling request transmitted to the vehicle dealership system on behalf of the customer may indicate the customer availability for viewing the one or more available vehicles in person at the vehicle dealership. The scheduling request may indicate days of a week (e.g., Tuesday, Saturday and Sunday) during which the customer is available to view and/or test drive the one or more available vehicles at the vehicle dealership. Further, the scheduling request may indicate times or time ranges (e.g., 10 am to 5 pm) during which the customer is available to view and/or test drive the one or more available vehicles at the vehicle dealership.

In some implementations, the vehicle dealership system may execute an application, which may receive the scheduling request from the scheduling system. The application that executes on the vehicle dealership system may verify that the vehicles indicated in the scheduling request are still available for sale at the vehicle dealership. The application that executes on the vehicle dealership system may access a calendar for a plurality of salespersons employed by the vehicle dealership. The application that executes on the vehicle dealership system may identify a period of time on the calendar, which corresponds to the customer availability, during which one of the salespersons is able to meet with the customer to show the one or more available vehicles or accompany the customer on test drive(s) of the one or more available vehicles. In some implementations, the application that executes on the vehicle dealership system may assess the customer information indicated in the scheduling request (e.g., the vehicle insurance and/or the financial information) and verify that the customer is qualified to test drive certain vehicles that are available for sale.

As shown by reference number 155, the one or more vehicle dealership systems may communicate with each other to facilitate an exchange of vehicles between the one or more vehicle dealerships. The one or more vehicle dealership systems may communicate with each other based on the one or more scheduling requests. As a result, vehicles may be collected from multiple vehicle dealerships for a showing at a single vehicle dealership or a common location, and the customer may interact with the available vehicles at the single vehicle dealership or the common location. The multiple vehicle dealerships may work together to share vehicles amongst the multiple vehicle dealerships. Vehicle dealerships may exchange vehicles having similar prices, and/or vehicle dealerships may purchase vehicles from other vehicle dealerships for a monetary value.

As an example, a first vehicle dealership system may receive, from the scheduling system, a scheduling request associated with a first vehicle. The first vehicle dealership may communicate with a second vehicle dealership to obtain a second vehicle that is similar to the first vehicle in terms of price, features, etc. A first vehicle dealership associated with the first vehicle dealership system may not have the second vehicle in stock, but a second vehicle dealership associated with the second vehicle dealership system may have the second vehicle in stock. As a result, the first vehicle dealership system may work together with the second vehicle dealership system to obtain the second vehicle at the first vehicle dealership, such that when a customer visits the first vehicle dealership, the customer may have an option to interact with both the first vehicle and the second vehicle.

In some implementations, multiple available vehicles may be interacted with at a common location that is shared by the one or more vehicle dealerships for facilitating interactions with the one or more available vehicles. For example, the one or more vehicle dealerships may each rent a portion of the common location, and rather than customers visiting individual vehicle dealerships, the customers may visit the common location to interact with available vehicles.

As shown by reference number 160, the scheduling system may receive, from the one or more vehicle dealership systems, one or more confirmation messages that confirm one or more interactions for the customer to view the one or more available vehicles. The scheduling system may receive the one or more confirmation messages based on the indication of the one or more available vehicles that the customer is interested in viewing, the customer information, and/or the availability information.

In some implementations, a confirmation message received from a vehicle dealership system may indicate one or more available vehicles with which the customer is scheduled to interact (e.g., view and/or test drive). The confirmation message may indicate a start time associated with an interaction for viewing the one or more available vehicles, a vehicle dealership name and location information associated with the vehicle dealership, the one or more available vehicles with which the customer is scheduled to interact, and/or a salesperson name that will be assisting the customer when the customer is visiting the vehicle dealership.

In some implementations, a confirmation message may indicate that a location to interact with the one or more available vehicles is a vehicle dealership or a common area shared by the one or more vehicle dealerships for facilitating interactions with the one or more available vehicles. Vehicle dealership systems may communicate with each other to facilitate an exchange of vehicles between the one or more vehicle dealerships. Exchanged vehicles may be interacted with by customers at the vehicle dealership or the common area shared by the one or more vehicle dealerships.

In some implementations, different vehicle dealerships may have different vehicles that may be of interest to the customer, so the scheduling system may transmit an individual scheduling request to each vehicle dealership system. The scheduling system may receive a confirmation message from each vehicle dealership system. As a result, the scheduling system may transmit multiple scheduling requests and receive multiple confirmation messages.

In some implementations, the scheduling system may resolve scheduling conflicts when scheduling appointments with the different vehicle dealership systems. For example, the scheduling system may transmit a scheduling request to multiple vehicle dealership systems indicating the customer availability, and multiple vehicle dealership systems may respond with a same appointment time. In other words, multiple appointments with different vehicle dealerships may conflict with each other, and in this case, the scheduling system may transmit updated customer availability and/or a request to modify a suggested time provided by one of the vehicle dealership systems.

As shown in FIG. 1F, and by reference number 165, the scheduling system may transmit, to the application executing on the client device, an indication of a schedule that indicates the one or more interactions for the customer to view the one or more available vehicles. The one or more interactions may be associated with one or more vehicle dealerships. The one or more available vehicles indicated on the schedule may be based on the vehicle preference information, the additional vehicle preference information, and/or the location information. Further, days and/or times associated with the one or more interactions may be based on the availability information associated with the customer.

In some implementations, the scheduling system may generate the schedule based on the one or more confirmation messages received from the one or more vehicle dealership systems. The scheduling system may start with a schedule that initially does not have any appointments at days/times during which the customer is available. As each confirmation message is received, the scheduling system may add an appointment onto the schedule. When all of the confirmation messages have been received and all of the appointments have been added onto the schedule, the scheduling system may transmit the indication of the schedule to the application. Alternatively, as each confirmation message is received at the scheduling system and a corresponding appointment is set up based on the confirmation message, the scheduling system may transmit an indication of the appointment to the application. In some cases, the application may receive several indications of new appointments over time as the appointments are being set up via the scheduling system.

In some implementations, the schedule may indicate, for each interaction scheduled on behalf of the customer, a start time associated with the interaction, a vehicle dealership name associated with the interaction, a vehicle dealership location associated with the interaction, and/or one or more available vehicles to be viewed during the interaction. The schedule may indicate, for each available vehicle to be viewed during the interaction, a make, model, year, price, color, etc. In some implementations, the schedule may indicate interactions with multiple vehicle dealerships and/or to view multiple available vehicles.

As an example, the schedule may indicate, that on a given day, the customer may be scheduled to visit three separate vehicle dealerships. A first appointment may start at 10 am with a first vehicle dealership, at which the customer may be scheduled to view and/or test drive three vehicles. Since the customer may interact with three available vehicles at the first vehicle dealership, the first appointment may be scheduled for a duration of time that is sufficient for the customer to interact with all three available vehicles. The three available vehicles at the first vehicle dealership may all be silver 2020 Honda CR-Vs, based on the search query with the vehicle preference information. A second appointment may start at 1 pm with a second vehicle dealership, at which the customer may be scheduled to view and/or test drive one vehicle. The vehicle available at the first vehicle dealership may be a silver 2020 Toyota RAV4, based on the additional search query with the additional vehicle preference information. A third appointment may start at 3 pm with a third vehicle dealership, at which the customer may be scheduled to view and/or test drive one vehicle. The vehicle available at the first vehicle dealership may be a silver 2020 Ford Escape, based on the additional search query with the additional vehicle preference information. The first vehicle dealership, the second vehicle dealership, and the third vehicle dealership may all be within a certain distance from each other and within a radius (in miles) of the customer's specified location. In other words, a travel time and/or distance between the first vehicle dealership and the second vehicle dealership, and a travel time and/or distance between the second vehicle dealership and the third vehicle dealership, may satisfy a threshold value.

As another example, the schedule may indicate, that on a given day, the customer may be scheduled to visit three separate locations. A first appointment may start at 10 am at a common location which may be shared by multiple vehicle dealerships, at which the customer may be scheduled to view and/or test drive three vehicles. The three vehicles may be associated with a first vehicle dealership. Alternatively, the three vehicles may be assembled from multiple vehicle dealerships and delivered to the common location. For example, the first vehicle dealership may have gathered two of the three vehicles from another vehicle dealership, based on communications between vehicle dealerships systems associated with the first vehicle dealership and the other vehicle dealership, respectively. A second appointment may start at 1 pm with a second vehicle dealership, at which the customer may be scheduled to view and/or test drive one vehicle. A third appointment may start at 3 pm with a third vehicle dealership, at which the customer may be scheduled to view and/or test drive one vehicle.

As shown by reference number 170, the application executing on the client device may display the schedule via the user interface associated with the application. The user interface may display a listing of different appointments on a given day. For each appointment, the user interface may display a start time, a vehicle dealership name, a vehicle dealership location, and one or more available vehicles and corresponding features that the customer is scheduled to view and/or test drive during the appointment.

In some implementations, the user interface may provide an option to confirm individual appointments indicated on the schedule, where a confirmation may be transmitted from the client device to the scheduling system. In some implementations, the user interface may provide an option to cancel an appointment indicated on the schedule, in which case a notification may be transmitted from the client device to the scheduling system. In this case, the scheduling system may notify an appropriate vehicle dealership system that the appointment has been canceled. In some implementations, the user interface may provide an option to indicate that the customer is running behind schedule and will be late for a next appointment (e.g., perhaps due to another appointment that runs late). In this case, a notification may be transmitted from the client device to the scheduling system, and the scheduling system may transmit the notification to a vehicle dealership system associated with the next appointment.

In some implementations, the user interface may provide an option to request a time change for an appointment indicated on the schedule, in which case a notification may be transmitted from the client device to the scheduling system. In this case, the scheduling system may notify an appropriate vehicle dealership system with the request for the time change for the appointment. If the request is granted by the vehicle dealership system, a confirmation may be transmitted by the vehicle dealership system to the scheduling system, and the scheduling system may transmit a notification to the client device that the request for the time change has been granted. In this case, the schedule displayed via the user interface may be updated to reflect an updated start time for the appointment.

In some implementations, the application that executes on the client device may facilitate the querying of vehicle inventory systems for scheduling of interactions to view available vehicles. The application may provide the user interface that enables the customer to provide the vehicle preference information, the location information, and/or the availability information. At this point, the customer does not need to perform any additional actions with respect to researching nearby vehicle dealerships and available vehicles at those vehicle dealerships. Further, the customer does not need to schedule appointments with those vehicle dealerships, either via phone or through websites associated with the vehicle dealerships. These actions may be performed at the scheduling system and may be transparent to the customer and the application that executes on the client device. The scheduling system may be responsible for querying the vehicle inventory system to identify available vehicles that are in a vicinity of the customer, and the scheduling system may be responsible for setting up appointments with vehicle dealerships based on communications with vehicle dealership systems associated with the vehicle dealerships. After the available vehicles are found and the appointments are established, the client device may receive an indication of a schedule of the appointments with pertinent information about each appointment. As a result, the customer saves time by not manually researching the available vehicles and setting up the appointments. The application may enhance a vehicle buying experience for the customer. Further, by offloading such actions to the scheduling system, the client device that executes the application may consume less processing and bandwidth, thereby reducing a power consumption at the client device.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram of an example environment 200 in which systems and/or methods described herein may be implemented. As shown in FIG. 2, environment 200 may include a client device 210, a customer information system 215, a scheduling system 220, a vehicle inventory system 225, a vehicle dealership system 230, and a network 240. Devices of environment 200 may interconnect via wired connections, wireless connections, or a combination of wired and wireless connections.

The client device 210 includes one or more devices capable of receiving, generating, storing, processing, and/or providing information associated with querying vehicle inventory systems for scheduling of interactions to view available vehicles, as described elsewhere herein. The client device 210 may include a communication device and/or a computing device. For example, the client device 210 may include a wireless communication device, a phone such as a smart phone, a mobile phone or a video phone, a user equipment, a laptop computer, a tablet computer, a desktop computer, or a similar type of device. In some implementations, the client device 210 may be used to connect to each of a plurality of virtual sessions associated with the aggregated virtual session.

The customer information system 215 includes one or more devices capable of receiving, generating, storing, processing, providing, and/or routing information associated with querying vehicle inventory systems for scheduling of interactions to view available vehicles, as described elsewhere herein. The customer information system 215 may include a communication device and/or a computing device. For example, the customer information system 215 may include a server, such as an application server, a client server, a web server, a database server, a host server, a proxy server, a virtual server (e.g., executing on computing hardware), or a server in a cloud computing system. In some implementations, the customer information system 215 includes computing hardware used in a cloud computing environment.

The scheduling system 220 includes one or more devices capable of receiving, generating, storing, processing, providing, and/or routing information associated with querying vehicle inventory systems for scheduling of interactions to view available vehicles, as described elsewhere herein. The scheduling system 220 may include a communication device and/or a computing device. For example, the scheduling system 220 may include a server, such as an application server, a client server, a web server, a database server, a host server, a proxy server, a virtual server (e.g., executing on computing hardware), or a server in a cloud computing system. In some implementations, the scheduling system 220 includes computing hardware used in a cloud computing environment.

The vehicle inventory system 225 includes one or more devices capable of receiving, generating, storing, processing, providing, and/or routing information associated with querying vehicle inventory systems for scheduling of interactions to view available vehicles, as described elsewhere herein. The vehicle inventory system 225 may include a communication device and/or a computing device. For example, the vehicle inventory system 225 may include a server, such as an application server, a client server, a web server, a database server, a host server, a proxy server, a virtual server (e.g., executing on computing hardware), or a server in a cloud computing system. In some implementations, the vehicle inventory system 225 includes computing hardware used in a cloud computing environment.

The vehicle dealership system 230 includes one or more devices capable of receiving, generating, storing, processing, providing, and/or routing information associated with querying vehicle inventory systems for scheduling of interactions to view available vehicles, as described elsewhere herein. The vehicle dealership system 230 may include a communication device and/or a computing device. For example, the vehicle dealership system 230 may include a server, such as an application server, a client server, a web server, a database server, a host server, a proxy server, a virtual server (e.g., executing on computing hardware), or a server in a cloud computing system. In some implementations, the vehicle dealership system 230 includes computing hardware used in a cloud computing environment.

The network 240 includes one or more wired and/or wireless networks. For example, the network 240 may include a cellular network, a public land mobile network, a local area network, a wide area network, a metropolitan area network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the client device 210, the customer information system 215, the scheduling system 220, the vehicle inventory system 225, and/or the vehicle dealership system 230. In some implementations, the client device 210, the customer information system 215, the scheduling system 220, the vehicle inventory system 225, and/or the vehicle dealership system 230 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

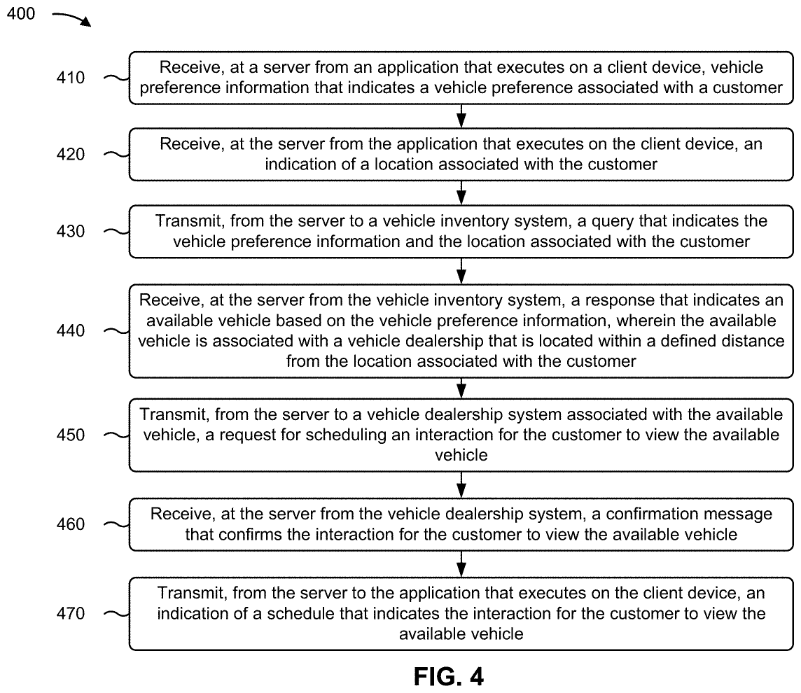

FIG. 4 is a flowchart of an example process 400 associated with querying vehicle inventory systems for scheduling of interactions to view available vehicles. In some implementations, one or more process blocks of FIG. 4 may be performed by a system (e.g., client device 210, customer information system 215, scheduling system 220, vehicle inventory system 225, and/or vehicle dealership system 230). In some implementations, one or more process blocks of FIG. 4 may be performed by another device or a group of devices separate from or including the system, such as client device 210, customer information system 215, scheduling system 220, vehicle inventory system 225, and/or vehicle dealership system 230. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving, at a server from an application that executes on a client device, vehicle preference information that indicates a vehicle preference associated with a customer (block 410). As further shown in FIG. 4, process 400 may include receiving, at the server from the application that executes on the client device, an indication of a location associated with the customer (block 420). As further shown in FIG. 4, process 400 may include transmitting, from the server to a vehicle inventory system, a search query that indicates the vehicle preference information and the location associated with the customer (block 430). As further shown in FIG. 4, process 400 may include receiving, at the server from the vehicle inventory system, a response that indicates an available vehicle based on the vehicle preference information (block 440). The available vehicle may be associated with a vehicle dealership that is located within a defined distance from the location associated with the customer. As further shown in FIG. 4, process 400 may include transmitting, from the server to a vehicle dealership system associated with the available vehicle, a request for scheduling an interaction for the customer to view the available vehicle (block 450). As further shown in FIG. 4, process 400 may include receiving, at the server from the vehicle dealership system, a confirmation message that confirms the interaction for the customer to view the available vehicle (block 460). The confirmation message may indicate that a location to interact with the available vehicle is the vehicle dealership or a common area shared by multiple vehicle dealerships for facilitating the interaction with the available vehicle. The vehicle dealership system may be configured to communicate with other vehicle dealership systems to facilitate an exchange of vehicles, and exchanged vehicles are available for interactions at the vehicle dealership or the common area shared by the multiple vehicle dealerships. As further shown in FIG. 4, process 400 may include transmitting, from the server to the application that executes on the client device, an indication of a schedule that indicates the interaction for the customer to view the available vehicle (block 470).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for querying vehicle inventory systems for scheduling of interactions to view available vehicles, the system comprising:
one or more memories; and
one or more processors, communicatively coupled to the one or more memories, configured to:
receive, from an application that executes on a client device, vehicle preference information that indicates a vehicle preference associated with a customer;
receive, from the application that executes on the client device, customer information that indicates one or more characteristics associated with the customer;
receive, from the application that executes on the client device, an indication of a location associated with the customer;
transmit, to a vehicle inventory system, a search query that indicates the vehicle preference information and the location associated with the customer, wherein the vehicle inventory system is associated with a database that stores vehicle availability information associated with a plurality of vehicle dealerships in a plurality of geographic locations;
receive, from the vehicle inventory system, a response that indicates one or more available vehicles that are retrieved from the database based on the search query indicating the vehicle preference information and the location associated with the customer, wherein the one or more available vehicles are associated with one or more vehicle dealerships of the plurality of vehicle dealerships, and wherein the one or more vehicle dealerships are located within a defined distance from the location associated with the customer;
transmit, to one or more vehicle dealership systems associated with the one or more available vehicles, one or more requests for scheduling one or more interactions for the customer to view the one or more available vehicles, wherein the one or more requests indicate the customer information;
receive, from the one or more vehicle dealership systems, one or more confirmation messages that confirm one or more interactions for the customer to view the one or more available vehicles, wherein a confirmation message of the one or more confirmation messages indicates that a location to interact with the one or more available vehicles is a vehicle dealership of the one or more vehicle dealerships or a common area shared by the one or more vehicle dealerships for facilitating interactions with the one or more available vehicles, wherein the one or more vehicle dealership systems are configured to communicate with each other to facilitate an exchange of vehicles between the one or more vehicle dealerships, and the one or more interactions include interactions with exchanged vehicles at the vehicle dealership or the common area shared by the one or more vehicle dealerships; and
transmit, to the application that executes on the client device, an indication of a schedule that indicates the one or more interactions for the customer to view the one or more available vehicles.

2. The system of claim 1, wherein the vehicle preference information indicates one or more of: a make associated with the vehicle, a model associated with the vehicle, a year associated with the vehicle, a price associated with the vehicle, a quantity of miles associated with the vehicle, or a color associated with the vehicle.

3. The system of claim 1, wherein the customer information indicates one or more of: financial information associated with the customer, a credit score associated with the customer, or insurance information associated with the customer.

4. The system of claim 1, wherein the one or more processors are further configured to:
receive, from the application that executes on the client device, availability information associated with the customer, wherein the one or more requests for scheduling the one or more interactions indicates the availability information associated with the customer, and wherein the schedule that indicates the one or more interactions for the customer is based on the availability information associated with the customer.

5. The system of claim 1, wherein the indication of the schedule indicates, for each interaction, a start time associated with the interaction, a dealership name associated with the interaction, a dealership location associated with the interaction, and one or more vehicles to be viewed during the interaction.

6. The system of claim 1, wherein the one or more processors are further configured to:
identify additional vehicle information based on the vehicle preference information, wherein the additional vehicle information indicates one or more vehicles having characteristics that are similar to the vehicle preference information; and
transmit, to the vehicle inventory system, an additional query that indicates the additional vehicle information, wherein the response received from the vehicle inventory system that indicates the one or more available vehicles is based on one or more of the vehicle preference information or the additional vehicle information.

7. The system of claim 1, wherein the one or more interactions are associated with a test drive of the one or more available vehicles.

8. A method of querying vehicle inventory systems for scheduling of interactions to view available vehicles, comprising:
receiving, at a server from an application that executes on a client device, vehicle preference information that indicates a vehicle preference associated with a customer;
receiving, at the server from the application that executes on the client device, an indication of a location associated with the customer;
transmitting, from the server to a vehicle inventory system, a search query that indicates the vehicle preference information and the location associated with the customer;
receiving, at the server from the vehicle inventory system, a response that indicates an available vehicle based on the vehicle preference information, wherein the available vehicle is associated with a vehicle dealership that is located within a defined distance from the location associated with the customer;
transmitting, from the server to a vehicle dealership system associated with the available vehicle, a request for scheduling an interaction for the customer to view the available vehicle;
receiving, at the server from the vehicle dealership system, a confirmation message that confirms the interaction for the customer to view the available vehicle, wherein the confirmation message indicates that a location to interact with the available vehicle is the vehicle dealership or a common area shared by multiple vehicle dealerships for facilitating the interaction with the available vehicle, wherein the vehicle dealership system is configured to communicate with other vehicle dealership systems to facilitate an exchange of vehicles, and exchanged vehicles are available for interactions at the vehicle dealership or the common area shared by the multiple vehicle dealerships; and
transmitting, from the server to the application that executes on the client device, an indication of a schedule that indicates the interaction for the customer to view the available vehicle.

9. The method of claim 8, wherein the vehicle preference information indicates one or more of: a make associated with the vehicle, a model associated with the vehicle, a year associated with the vehicle, a price associated with the vehicle, a quantity of miles associated with the vehicle, or a color associated with the vehicle.

10. The method of claim 8, further comprising:
receiving, from the application that executes on the client device, customer information that indicates one or more characteristics associated with the customer, wherein the request for scheduling the interaction indicates the customer information, and wherein the confirmation message is received based on the customer information.

11. The method of claim 10, wherein the customer information indicates one or more of: financial information associated with the customer, a credit score associated with the customer, or insurance information associated with the customer.

12. The method of claim 8, further comprising:
receiving, from the application that executes on the client device, availability information associated with the customer, wherein the one or more requests for scheduling the one or more interactions indicates the availability information associated with the customer, and wherein the schedule that indicates the one or more interactions for the customer is based on the availability information associated with the customer.

13. The method of claim 8, wherein the indication of the schedule indicates a start time associated with the interaction, a dealership name associated with the interaction, a dealership location associated with the interaction, and features of the available vehicle to be viewed during the interaction.

14. The method of claim 8, further comprising:
identifying additional vehicle information based on the vehicle preference information, wherein the additional vehicle information indicates one or more vehicles having characteristics that are similar to the vehicle preference information; and
transmitting, to the vehicle inventory system, an additional query that indicates the additional vehicle information, wherein the response received from the vehicle inventory system that indicates the available vehicle is based on one or more of the vehicle preference information or the additional vehicle information.

15. The method of claim 8, wherein the interaction is associated with a test drive of the available vehicle.

16. A non-transitory computer-readable medium storing a set of instructions, the set of instructions comprising:
one or more instructions that, when executed by one or more processors of a device, cause the device to:
receive, at an application that executes on a client device, vehicle preference information that indicates a vehicle preference associated with a customer;
receive, at the application that executes on the client device, customer information that indicates one or more characteristics associated with the customer;
receive, at the application that executes on the client device, an indication of a location associated with the customer;
transmit, from the application that executes on the client device to a server, the vehicle preference information, the customer information, and the indication of the location associated with the customer;
receive, at the application that executes on the client device from the server, an indication of a schedule that indicates one or more interactions for the customer to view one or more available vehicles, wherein the one or more available vehicles are based on the vehicle preference information, the customer information, and the indication of the location associated with the customer, wherein a location to interact with the one or more available vehicles is one or more vehicle dealerships that are located within a defined distance from the location associated with the customer or a common area shared by the one or more vehicle dealerships for facilitating interactions with the one or more available vehicles, and wherein the one or more available vehicles at the location include exchanged vehicles between the one or more vehicle dealerships; and
provide the indication of the schedule for display on a user interface of the client device.

17. The non-transitory computer-readable medium of claim 16, wherein the one or more instructions, when executed by the one or more processors, further cause the device to:
receive, at the application that executes on the client device, availability information associated with the customer, wherein the schedule that indicates the one or more interactions for the customer is based on the availability information associated with the customer.

18. The non-transitory computer-readable medium of claim 16, wherein the indication of the schedule that indicates the one or more interactions for the customer is based on: a search query to a vehicle inventory system that indicates the vehicle preference information and the location associated with the customer, and a response from the vehicle inventory system that indicates a plurality of available vehicles are associated with the one or more vehicle dealerships that are located within the defined distance from the location associated with the customer.

19. The non-transitory computer-readable medium of claim 16, wherein:
the vehicle preference information indicates one or more of: a make associated with the vehicle, a model associated with the vehicle, a year associated with the vehicle, a price associated with the vehicle, a quantity of miles associated with the vehicle, or a color associated with the vehicle; and
the customer information indicates one or more of: financial information associated with the customer, a credit score associated with the customer, or insurance information associated with the customer.

20. The non-transitory computer-readable medium of claim 16, wherein the indication of the schedule indicates, for each interaction, a start time associated with the interaction, a dealership name associated with the interaction, a dealership location associated with the interaction, and one or more vehicles to be viewed during the interaction.
